(19) United States
(12) Patent Application Publication
(10) Pub. No.: US 2025/0383049 A1
(43) Pub. Date: Dec. 18, 2025

(54) HANDLING MACHINE COMPRISING A ROTATABLE CHASSIS AND A FUEL CELL

(71) Applicant: MANITOU BF, ANCENIS (FR)

(72) Inventors: Valentin BREHIER, ANCENIS (FR); Maurice BESSEAU, ANCENIS (FR); Xavier SCHELL, ANCENIS (FR)

(21) Appl. No.: 18/875,013

(22) PCT Filed: May 26, 2023
(86) PCT No.: PCT/EP2023/064186

§ 371 Date: Dec. 13, 2024

(30) Foreign Application Priority Data
Jun. 14, 2022 (FR) FR2205752

(51) Int. Cl. F17C 7/00; B66F 9/065; B66F 9/20

(52) U.S. Cl. CPC F17C 7/00; B66F 9/0655; B66F 9/205; F17C 2205/0352; F17C 2221/012; F17C 2223/0123; F17C 2223/036; F17C 2260/04; F17C 2265/06; F17C 2270/0184

(57) ABSTRACT

The invention relates to a handling machine (1) comprising:
a rotating chassis;
a lifting arm (7);
a first assembly comprising a device for storing electrical energy (9);
a second assembly comprising a fuel cell (10) which is connected to the device for storing electrical energy (9) via a connecting circuit (35); and
a third assembly comprising at least one tank (11);
   wherein one of the first, the second and the third assemblies is fixed to one of the lower and upper structures (2, 3) and the two others of the first, second and third assemblies are fixed to the other of the lower and upper structures (2, 3);

### TECHNICAL FIELD

The invention relates to the field of handling machines comprising a rotating chassis in two parts, i.e. comprising a lower structure and an upper structure rotatably mounted on the lower structure about a vertical axis, a lifting arm which is movably mounted on the upper structure, in addition to a system for producing and storing electrical energy from hydrogen.

### TECHNOLOGICAL BACKGROUND

The document U.S. Pat. No. 6,688,481 discloses a crane which comprises a rotating chassis in two parts with a lower structure and an upper structure rotatably mounted on the lower structure. The crane also comprises a telescopic arm which is mounted in an articulated manner on the upper structure of the chassis and an electric motor which is configured to provide the propulsion of the crane. In one embodiment, the crane comprises a fuel cell system which is connected to the electric motor in order to supply it with electrical energy. The fuel cell system is arranged on a rear part of the upper structure of the chassis in order to form a counterweight.

Such a handling machine is not entirely satisfactory. More specifically, in the aforementioned embodiment the fuel cell constitutes an alternative to the use of a battery. With such a design, in the absence of a buffer storage device for storing surplus energy produced by the fuel cell and restoring it in the event of an increase in the power demand of the vehicle, the fuel cell has to be controlled such that the power produced is adapted in real time to the power demand of the electric motor, which can prematurely damage the fuel cell and also proves difficult to implement in practice, taking account in particular of the slow responsiveness of the fuel cells to the demands for changing power. Moreover, the aforementioned document does not comprise any teaching regarding the arrangement of the hydrogen tank which is designed to supply hydrogen to the fuel cell, nor regarding the measures enabling the safety of such a handling machine to be ensured.

### SUMMARY

One idea forming the basis of the invention is to propose a handling machine comprising a rotating chassis which is provided with a system for producing and storing electrical energy from hydrogen, which provides a greater flexibility of use and in which the arrangement of the components of said system for producing and storing electrical energy is adapted to the structural features of such a machine so as to guarantee a greater degree of safety.

According to a first subject, the invention relates to a handling machine comprising:
a chassis comprising a lower structure and an upper structure rotatably mounted on the lower structure about a vertical axis;
a lifting arm which is movably mounted on the upper structure;
a first assembly comprising a device for storing electrical energy,
a second assembly comprising a fuel cell which is configured to generate electrical energy designed to be stored in the device for storing electrical energy, said fuel cell being electrically connected to the device for storing electrical energy via a connecting circuit; and
a third assembly comprising at least one tank designed to contain hydrogen and connected to the fuel cell via a supply line in order to supply it with hydrogen;
said supply line comprising a pressure controller, an upstream portion connecting the tank and the pressure controller and a downstream portion connecting the pressure controller and the fuel cell;
wherein one of the first, the second and the third assemblies is fixed to one of the lower and upper structures and the two others of the first, second and third assemblies are fixed to the other of the lower and upper structures;
wherein the pressure controller and the upstream portion of the supply line are fixed to that of the lower and upper structures to which the third assembly is fixed; and
wherein the handling machine comprises a rotating joint connecting the lower structure and the upper structure and via which the downstream portion of the supply line and/or the connecting circuit passes.

Due to the aforementioned features, the three aforementioned assemblies are distributed over the two lower and upper structures, which, in particular, makes it possible to optimize the capacities of the one or more tanks and of the device for storing electrical energy. Moreover, since the pressure controller and the upstream portion of the supply line are fixed to the same lower or upper structure as the tank, the upstream portion of the supply line, i.e. its “high pressure” portion which is most critical regarding the risk of fire, is located on only one of the lower and upper structures. This avoids passing this high pressure portion between the lower and upper structures and thus provides a greater degree of safety.

According to the embodiments, such a handling machine can have one or more of the following features.

According to one embodiment, one of the first, the second and the third assemblies is fixed to the upper structure and the two others of the first, second and third assemblies are fixed to the lower structure and housed in a first box and a second box of said lower structure. Such an arrangement makes it possible to separate the device for storing electrical energy from the tank and the fuel cell, which moves it away from leakages of hydrogen which are liable to be produced and limits even further the risk of fire. This also insulates the device for storing electrical energy from the heat generated by the fuel cell and thus limits the risk of overheating of said device for storing electrical energy.

According to one embodiment, the first box and the second box are formed in the lower structure on either side of a longitudinal median plane of the handling machine. This contributes to the lateral balance of the handling machine.

According to one embodiment, the handling machine comprises a driver's cab mounted on the upper structure, and that of the first, second and third assemblies which is fixed to the upper structure and said driver's cab are positioned on either side of the lifting arm. This also contributes to the lateral balance of the handling machine.

According to one embodiment, the first assembly, the second assembly and the connecting circuit are fixed to the lower structure, the third assembly, the pressure controller and the upstream portion of the supply line being fixed to the upper structure and the downstream portion of the supply line passing via the rotating joint. Such an arrangement permits the use of one or more tanks having a greater capacity than when they have to be housed inside the lower structure, which as a result improves the autonomy of the handling machine.

According to a further embodiment, the first assembly, the third assembly, the pressure controller and the upstream portion of the supply line are fixed to the lower structure, the second assembly being fixed to the upper structure and the downstream portion of the supply line and the connecting circuit passing via the rotating joint. Thus the tank can be housed in a box which provides excellent protection against falling objects.

According to a further embodiment, the second assembly, the third assembly and the supply line are fixed to the lower structure, the first assembly being fixed to the upper structure and the connecting circuit passing via the rotating joint. Thus the tank can be housed in a box which provides excellent protection against falling objects.

According to further embodiments, one of the first, the second and the third assemblies is fixed to the lower structure and the two others of the first, second and third assemblies are fixed to the upper structure and housed in a first box and a second box of said upper structure. Such an arrangement also makes it possible to separate the device for storing electrical energy from the tank and the fuel cell.

According to one embodiment, the first box and the second box are formed in the upper structure on either side of the lifting arm. This contributes to the lateral balance of the handling machine.

According to one embodiment, the first assembly, the third assembly, the pressure controller and the upstream portion of the supply line are fixed to the upper structure, the second assembly being fixed to the lower structure and the downstream portion of the supply line and the connecting circuit passing via the rotating joint.

According to one embodiment, the first assembly, the second assembly and the connecting circuit are fixed to the upper structure, the third assembly, the pressure controller and the upstream portion of the supply line being fixed to the lower structure, and the downstream portion of the supply line passing via the rotating joint.

According to one embodiment, the second assembly, the third assembly, the pressure controller and the supply line are fixed to the upper structure, the first assembly being fixed to the lower structure and the connecting circuit passing via the rotating joint.

According to one embodiment, the handling machine contains a front axle and a rear axle which are mounted on the lower structure and each comprise two wheels.

According to one embodiment, the first box and the second box are located between the front axle and the rear axle.

According to one embodiment, the device for storing electrical energy comprises one or more batteries and/or one or more supercapacitors.

According to one embodiment, the handling machine comprises a plurality of tanks.

According to one embodiment, the or each tank is a pressurized hydrogen tank suitable for the storage of hydrogen at a maximum pressure of between 300 and 700 bar.

According to one embodiment, the second assembly comprises a compressor making it possible to compress the combustion air at the inlet of the fuel cell and a cooling device making it possible to cool the fuel cell.

According to one embodiment, the handling machine comprises at least two electric motors respectively configured to displace the lifting arm and to displace the handling machine, said electric motors being fixed to the lower structure and being connected to the fuel cell and to the device for storing electrical energy by an energy distribution device.

According to one embodiment, the handling machine comprises two electric motors which are respectively coupled to the front axle and the rear axle by a transmission device, said electric motors being connected to the fuel cell and to the device for storing electrical energy by an energy distribution device.

According to one embodiment, the handling machine comprises an electric motor which is coupled to the front axle and the rear axle by a transmission device, said electric motor being fixed to the lower structure and connected to the fuel cell and to the device for storing electrical energy by an energy distribution device.

According to one embodiment, the motor for actuating the lifting arm is a motor driving a hydraulic pump, the hydraulic pump being connected to one or more hydraulic actuators arranged to displace the lifting arm.

### BRIEF DESCRIPTION OF THE FIGURES

The invention will be better understood and further objects, details, features and advantages thereof will appear more clearly during the course of the following description of several particular embodiments of the invention, provided solely in an illustrative and non-limiting manner, with reference to the accompanying drawings.

FIG. 1 is a schematic side view of a handling machine according to a first embodiment.

FIG. 2 is a schematic view from above of the handling machine according to the first embodiment.

FIG. 3 is a schematic view of the electric circuit of the first embodiment.

FIG. 4 is a schematic view of the hydrogen circuit of the first embodiment.

FIG. 5 is a schematic side view of a handling machine according to a second embodiment.

FIG. 6 is a schematic view from above of the handling machine according to the second embodiment.

FIG. 7 is a schematic view of the hydrogen circuit of the second embodiment.

FIG. 8 is a schematic view of the electric circuit of the second embodiment.

FIG. 9 is a schematic side view of a handling machine according to a third embodiment.

FIG. 10 is a schematic view from above of the handling machine according to the third embodiment.

FIG. 11 is a schematic view of the hydrogen circuit of the third embodiment.

FIG. 12 is a schematic view of the electric circuit of the third embodiment.

FIG. 13 is a schematic side view of a handling machine according to a fourth embodiment.

FIG. 14 is a schematic view from the rear of the handling machine according to the fourth embodiment.

FIG. 15 is a schematic view from the rear of a handling machine according to a fifth embodiment.

FIG. 16 is a schematic view from the rear of a handling machine according to a sixth embodiment.

FIG. 17 is a schematic illustration of a rotating joint via which the hydrogen circuit passes.

### DESCRIPTION OF EMBODIMENTS

Conventionally, the “longitudinal” direction of the handling machine 1 corresponds to the front-rear orientation of the handling machine. In addition, the “longitudinal” direction of the upper structure 3 of the chassis corresponds to said front-rear orientation of the handling machine 1 when the upper structure 3 is in a configuration in which its angle of rotation relative to the lower structure 2 is zero. Moreover, the “transverse” direction is oriented perpendicularly to the longitudinal direction.

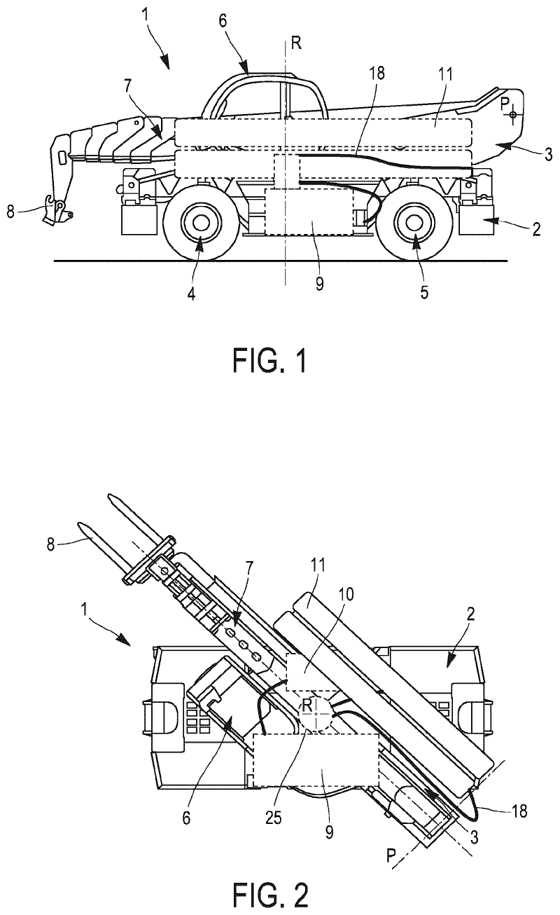

With reference to FIGS. 1 to 4, a handling machine 1 is described according to a first embodiment. The handling machine 1 comprises a mobile chassis. More particularly, as shown in FIGS. 1 and 2, the chassis comprises a lower structure 2 and an upper structure 3 which is rotatably mounted on the lower structure 2 about a vertical axis R. The handling machine 1 comprises two axles, a front axle 4 and a rear axle 5, which are each fixed to the lower structure 2 along a transverse axis and are each provided with two wheels, one at the left and the other at the right. At least one of the two front 4 and rear 5 axles is rotatably mounted about its axis in order to ensure the displacement of the chassis. The front 4 and rear 5 axles can also be fixed to the lower structure 2 with an option of clearance about the longitudinal axis so as to compensate for the inclined position of the handling machine 1.

Moreover, the handling machine 1 comprises a driver's cab 6 in which a driver can be seated and which is provided, in particular, with a seat, not shown, and equipment for controlling the handling machine 1. The driver's cab 6 is fixed to the upper structure 3. The handling machine 1 also comprises a lifting arm 7 which is, for example, a telescopic arm. In this case, the handling machine 1 can, in particular, be a telescopic forklift. The lifting arm 7 is mounted in an articulated manner on the upper structure 3 of the chassis so as to be pivotably movable about a transverse pivot axis P. The lifting arm 7 extends in a longitudinal median plane of the upper structure 3. The lifting arm 7 can be implemented in different ways, in particular in the form of a plurality of telescopic sections or as a variant in the form of an arm of fixed length. One end of the lifting arm 7 opposing the pivot axis P can carry a working implement 8 or a modular tool carrier capable of receiving working implements 8 of several types. “Working implement” 8 denotes, for example, a pair of forks, a bucket, a hoist, a claw or the like.

The handling machine 1 comprises one or more linear actuators, not shown, such as hydraulic actuators which are each mounted in an articulated manner, on the one hand, on the lifting arm 7 and, on the other hand, on the upper structure 3, which makes it possible to pivot the lifting arm 7 relative to the upper structure 3 about the pivot axis P. The hydraulic actuators are connected to a hydraulic circuit provided with a hydraulic pump which is driven by a motor such as an electric motor, also not shown in FIGS. 1 and 2. The hydraulic pump and the electric motor are fixed, for example, to the upper structure 3. They can be housed, in particular, in a space formed below the driver's cab 6.

Moreover, the handling machine 1 comprises at least one electric motor, also not shown in FIGS. 1 and 2, which is configured to provide the displacement of the handling machine 1. The one or more electric motors are housed, for example, between two longitudinal members of the lower structure 2 which extend parallel to the longitudinal median axis, respectively on either side of said longitudinal median axis.

According to one embodiment, the handling machine 1 comprises two electric motors which ensure the displacement thereof and which are each mounted in a space positioned inside the lower structure 2. In this case, each electric motor is coupled to one of the front 4 or rear 5 axles by means of a transmission device comprising, for example, a reducer and a differential. Thus the handling machine 1 has four drive wheels. Alternatively, the transmission device is a hydraulic transmission device. In such a case, the one or more electric motors can be mounted inside the lower structure 2 of the chassis or even inside the upper structure 3. In this last scenario, the handling machine comprises a rotating joint which is configured to ensure the transmission of hydraulic fluid from the upper structure 3 to the lower structure 2.

The handling machine 1 also comprises a system for producing and storing electrical energy from hydrogen, in order to supply electrical energy to at least one and preferably all of the aforementioned electric motors. The system for producing and storing electrical energy comprises the three following assemblies:
a first assembly comprising a device for storing electrical energy 9,
a second assembly comprising a fuel cell 10 which is configured to generate electrical energy designed to be stored in the device for storing electrical energy 9 and
a third assembly comprising at least one tank 11 which is designed to contain hydrogen and which is connected to the fuel cell 10.

The device for storing electrical energy 9 contains one or more batteries and/or one or more supercapacitors.

In a manner known per se, the fuel cell 10 is the basis of a redox reaction which transforms the hydrogen coming from the tank 11 and the oxygen from the air into electricity, water and heat. Advantageously the second assembly also comprises a compressor, not shown, making it possible to compress the combustible air at the inlet of the cells of the fuel cell 10, in addition to a cooling device, also not shown, making it possible to cool the fuel cell 10.

The or each tank 11 is suitable, for example, for storing hydrogen in the gaseous state at a maximum pressure of between 300 and 700 bar, for example in the order of 350 bar.

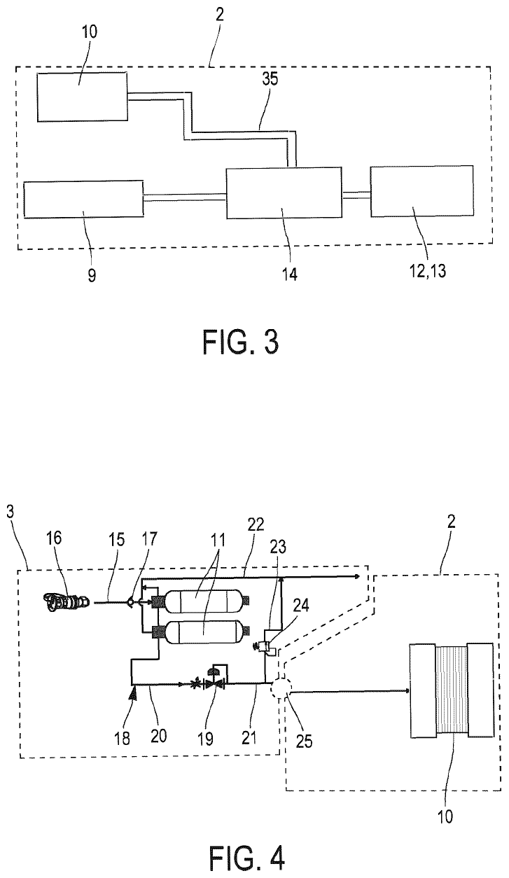

FIG. 3 illustrates schematically the electrical equipment of the handling machine 1 in addition to the corresponding circuit. The fuel cell 10 is connected to the device for storing electrical energy 9 and to one or more electrical energy consumers 12, 13 by a connecting circuit 35 provided with an energy distribution device 14. The energy distribution device 14 comprises, in particular, a DC/DC voltage converter which makes it possible to convert the level of voltage delivered by the fuel cell 10 to the level of voltage required by the device for storing electrical energy 9 and by the electrical energy consumers 12, 13. The energy distribution device 14 is also configured to conduct electrical energy, produced by the fuel cell 10 to the device for storing electrical energy 9, toward one or more electrical energy consumers 12, 13 or to redistribute the power between the device for storing electrical energy 9 and the one or more electrical energy consumers 12, 13. The electrical energy consumers can contain, in particular, one or more electric motors 12 configured to ensure the displacement of the handling machine 1 and/or an electric motor 13 driving a hydraulic pump to supply the hydraulic actuators, making it possible to displace the lifting arm 7.

FIG. 4 illustrates a hydrogen circuit according to one embodiment. The hydrogen circuit comprises a filling line 15 which is provided with a filler neck 16 which is designed to receive a filler nozzle of a hydrogen filling station and which leads to an inlet valve 17 leading to one or more tanks 11. The hydrogen circuit also comprises a supply line 18 designed to conduct hydrogen from the tank 11 to the fuel cell 10. The supply line 18 comprises a pressure controller 19 which makes it possible to reduce the pressure in order to supply the fuel cell 10 with hydrogen which has a pressure compatible with its function, i.e. lower than that at which it is stored in the tank 11. Conventionally, the portion of the supply line 18 which is arranged upstream of the pressure controller 19 is denoted as the high pressure portion 20 while the portion arranged downstream thereof is denoted as the low pressure portion 21. Moreover, the hydrogen circuit comprises a drainage circuit 22 which makes it possible to drain the contents of the one or more tanks 11, in particular in an emergency. Moreover, in the embodiment shown, the hydrogen circuit comprises a pressure control circuit 23 which is connected to the low pressure portion 21 and which is provided with a pressure control valve 24. The pressure control valve 24 is configured to discharge the hydrogen circulating in the low pressure portion 21 when the pressure thereof is greater than the set pressure thereof, which makes it possible to protect the fuel cell 10.

Returning to FIGS. 1 and 2, it can be seen that the device for storing electrical energy 9 and the fuel cell 10 are fixed to the lower structure 2, while the tanks 11 are fixed to the upper structure 3. More particularly, the device for storing electrical energy 9 and the fuel cell 10 are respectively housed in a first box and a second box of the lower structure 2. The first box and the second box are respectively formed on either side of the longitudinal median plane of the handling machine 1. Moreover, the one or more tanks 11 are fixed to the upper structure 3, on the side opposing the driver's cab 6, i.e. on the right-hand side in the embodiment shown. In other words, the one or more tanks 11 and the driver's cab 6 are positioned on either side of the lifting arm 7. Advantageously, according to one embodiment, not shown, the handling machine 1 is provided with a metal protective structure which is fixed to the upper structure 3 and positioned above the one or more tanks 11 so as to protect them against falling objects.

In FIGS. 3 and 4, the lower structure 2 and the upper structure 3 of the chassis are shown by polygons in dashed lines. As shown in FIG. 4, the pressure controller 19 and the tank(s) 11 are fixed to the upper structure 3. Thus the high pressure portion 20 of the supply line 18, which is the most critical regarding safety and in particular the risk of fire, is located only on the upper structure 3. This avoids passing the high pressure portion 20 between the lower 2 and upper 3 structures and thus provides a greater degree of safety. Moreover, as shown in FIG. 4, the low pressure portion 21 of the supply line 18 passes via a rotating joint 25 which is configured to permit the transmission of hydrogen from the upper structure 3 to the lower structure 2.

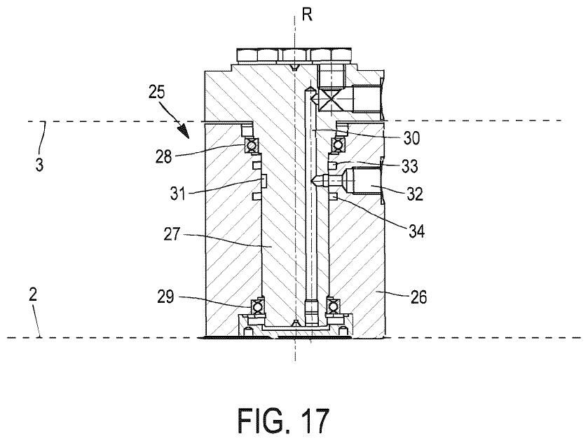

By way of example, a rotating joint 25 according to one conceivable embodiment is shown in FIG. 17. The rotating joint 25 comprises a frame 26 which has a recess in which a shaft 27 is fitted. The shaft 27 is rotatably mounted along the axis of rotation R, here by means of a pair of rolling bearings 28, 29. In the embodiment shown, the shaft 27 is fixed in terms of rotation to the upper structure 3 while the frame 26 is fixed in terms of rotation to the lower structure 2. According to a further variant, the structure is reversed, i.e. the shaft 27 and the frame 26 are respectively fixed in terms of rotation to the lower structure 2 and the upper structure 3. The shaft 27 comprises a channel 30, one end thereof being designed to be connected to an upstream part of the low pressure portion 21 of the supply line 18, i.e. that which is arranged on the upper structure 3 of the chassis. The channel opens into an annular groove 31 formed on an external surface of the shaft 27. Moreover, the frame 26 also comprises a channel 32 which opens opposite the annular groove 31 and which is designed to be connected to a downstream part of the low pressure portion 21 of the supply line 18, i.e. that which is arranged on the lower structure 2 of the chassis. Moreover, the rotating joint 25 comprises two annular sealing joints 33, 34 which are housed in the grooves formed in the frame 26 on either side of the annular groove 31.

In the embodiment of FIGS. 1 to 4, the one or more tanks 11 are not housed in a closed casing, which avoids the creation of pockets of gas in the case of leakage from a tank 11. Finally, this arrangement avoids the transmission of energy produced by the fuel cell 10 through the rotating joint 25 which makes it possible to simplify its design and avoids passing both hydrogen and electrical energy produced by the fuel cell 10 through the rotating joint 25, which increases safety.

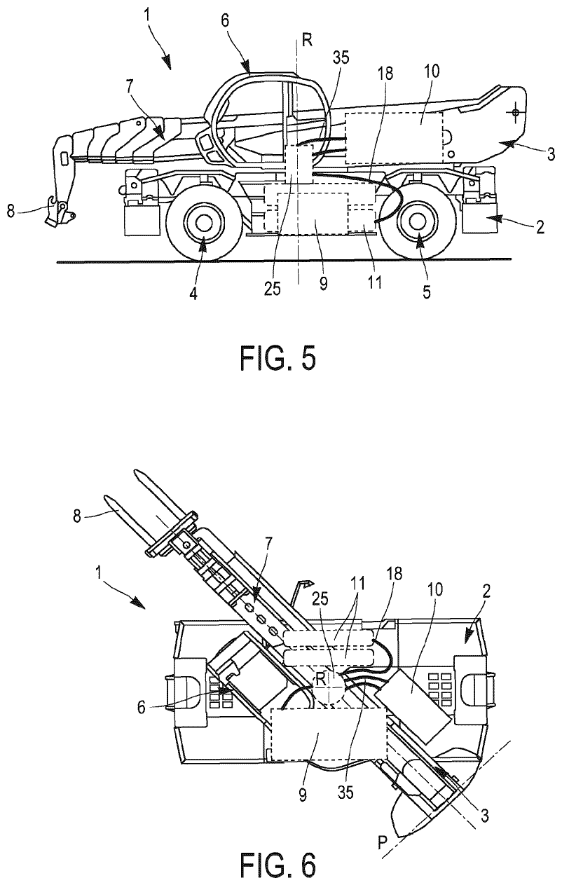

With reference to FIGS. 5 to 8, a handling machine 1 is described according to a second embodiment. This embodiment differs from that described above in relation to FIGS. 1 to 4 by the arrangement of the device for storing electrical energy 9, the fuel cell 10 and the one or more tanks 11. In this embodiment, the device for storing electrical energy 9 and the tanks 11 are fixed to the lower structure 2 while the fuel cell 10 is fixed to the upper structure 3. More particularly, the device for storing electrical energy 9 and the tank(s) 11 are respectively housed in a first box and a second box of the lower structure 2. As in the first embodiment, the first box and the second box are respectively formed on either side of the longitudinal median plane of the handling machine 1. Moreover, the fuel cell 10 is fixed to the upper chassis 3 on the side opposing the driver's cab 6, i.e. on the right-hand side in the embodiment shown. Advantageously, according to one embodiment, not shown, the handling machine 1 is provided with a metal protective structure which is positioned above the fuel cell 10 and which makes it possible to protect it against falling objects.

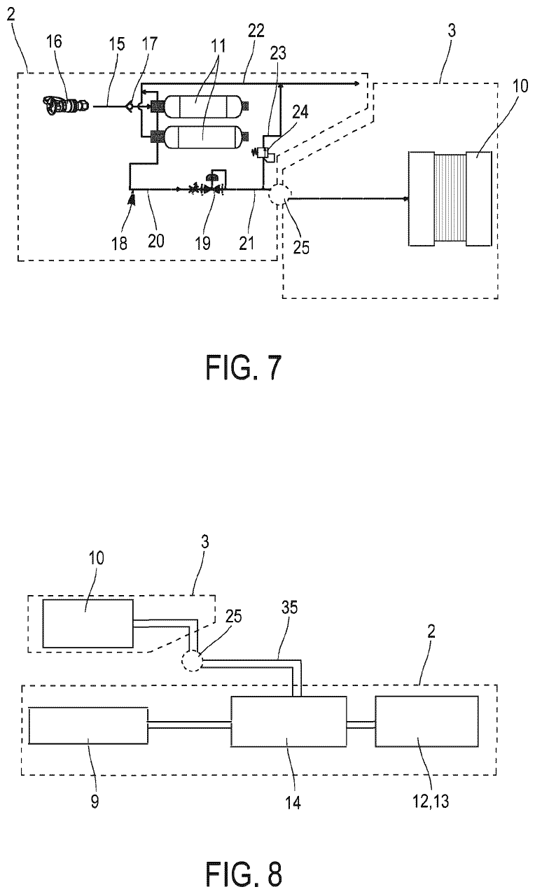

As shown in FIG. 7, the pressure controller 19 is mounted with the tank(s) 11 on the lower structure 2. Thus the high pressure portion 20 of the supply line 18, which is the most critical regarding safety and in particular the risk of fire, is located only on the lower structure 2, which also avoids passing this high pressure portion 20 between the lower 2 and upper 3 structures and thus provides a greater degree of safety. The low pressure portion 21 of the supply line 18 also passes via a rotating joint 25 which is configured to permit the transmission of hydrogen from the lower structure 2 to the upper structure 3.

Moreover, in this embodiment, as shown in FIG. 8, the connecting circuit 35 which connects the fuel cell 10 to the energy distribution device 14 also passes via the rotating joint 25. The rotating joint 25 is thus also configured to permit the transmission of electricity between the lower structure 2 and the upper structure 3. To achieve this, by way of example, the shaft 27 of the rotating joint 25 comprises two conductive rings which are each electrically connected to a terminal of the fuel cell 10, while the frame 26 comprises two brushes respectively cooperating with both of the two conductive rings and connected to the energy distribution device 14.

The embodiment of FIGS. 5 to 8 is advantageous, in particular, in that the one or more tanks 11 are housed in a box, which provides, in particular, an excellent protection against falling objects.

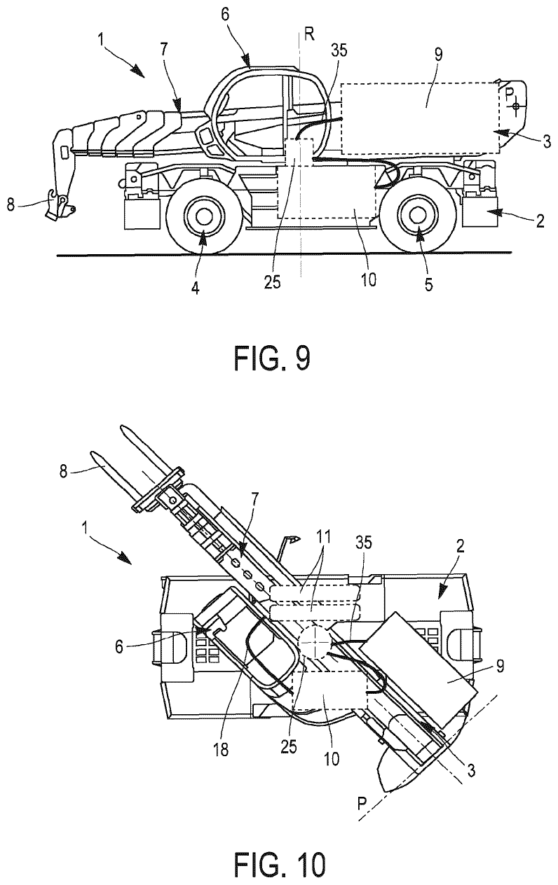

With reference to FIGS. 9 to 12, a handling machine 1 is described according to a third embodiment. This embodiment differs from those described above by the arrangement of the device for storing electrical energy, the fuel cell 10 and the one or more tanks 11. In this embodiment, the fuel cell 10 and the tank(s) 11 are fixed to the lower structure 2 while the device for storing electrical energy 9 is fixed to the upper structure 3. The fuel cell 10 and the tank(s) 11 are respectively housed in a first box and a second box of the lower structure 2. Advantageously, according to one embodiment, not shown, the handling machine 1 is provided with a metal protective structure which is fixed to the upper structure 3 and positioned above the device for storing electrical energy 9, which makes it possible to protect it against falling objects.

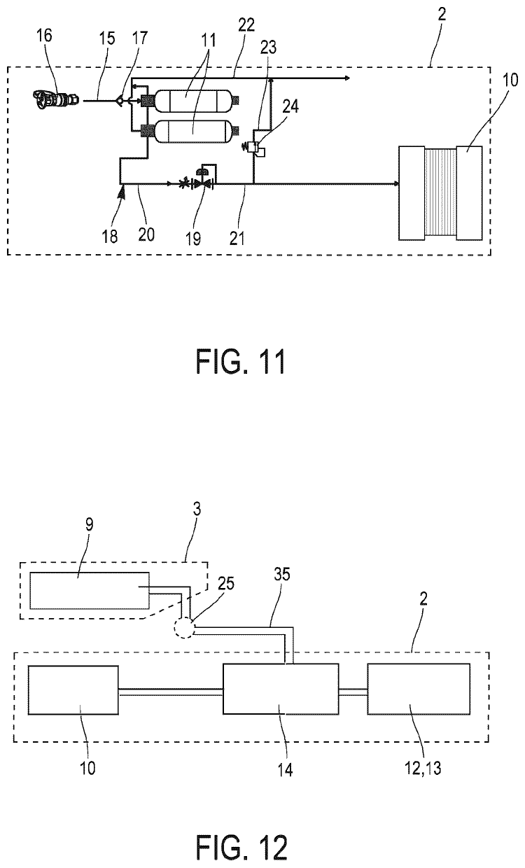

As shown in FIG. 11, the entire hydrogen circuit and, in particular, the high pressure portion 20 of the supply line 18 are located on the lower structure 2, which also avoids passing this high pressure portion 20 between the lower 2 and upper 3 structures and thus provides a greater degree of safety.

Moreover, in this embodiment, as shown in FIG. 12, the connecting circuit 35 which connects the fuel cell 10 to the energy distribution device 14 thus passes via the rotating joint 25. The rotating joint 25 is thus configured to permit the transmission of electricity between the lower structure 2 and the upper structure 3 as in the above embodiment of FIGS. 5 to 8.

In the embodiment of FIGS. 9 to 12, the one or more tanks 11 are housed in a box which provides, in particular, excellent protection against falling objects.

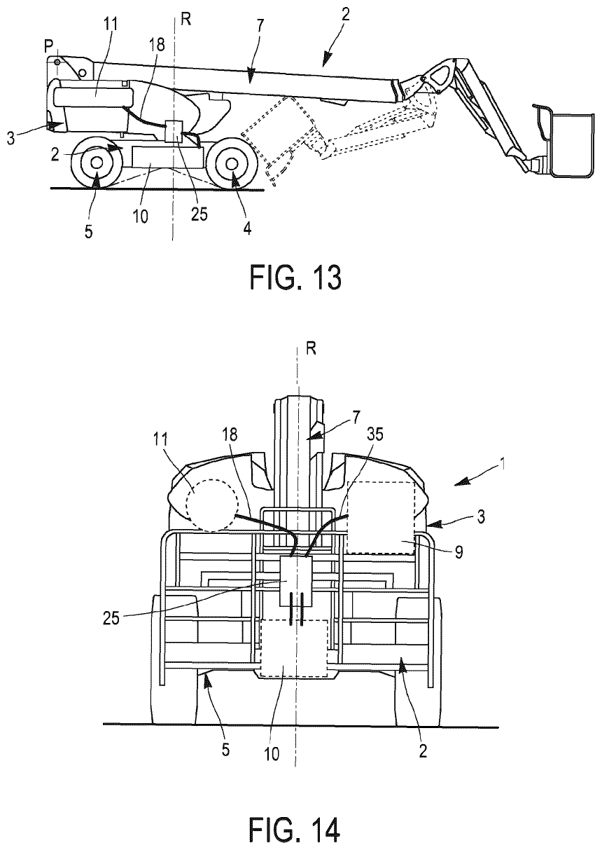

FIGS. 13 to 16 illustrate a handling machine 1 according to further embodiments. In these embodiments, the handling machine 1 is a platform for lifting people. Such a handling machine 1 differs, in particular, from that described above in that a cage designed to receive one or more people is fixed to the end of the lifting arm 7. Moreover, such a handling machine 1 has no driver's cab. The result of the aforementioned structure is that the upper structure 3 also has more space available for receiving equipment of the system for producing and storing electrical energy than the lower structure 2. Moreover, while in the above embodiments two of the three assemblies of the system for producing and storing electrical energy were fixed to the lower structure 2, in the embodiments which are shown in FIGS. 13 to 16 two of the three assemblies of the system for producing and storing electrical energy are fixed to the upper structure 3.

In the embodiment shown in FIGS. 13 and 14, the device for storing electrical energy 9 and the tank(s) 11 are fixed to the upper structure 3, while the fuel cell 10 is mounted inside the lower structure 2. More particularly, the device for storing electrical energy 9 and the tank(s) 11 are respectively housed in a first box and a second box of the upper structure 3. The first box and the second box are in this case formed on either side of the lifting arm 7. The pressure controller 19 is mounted with the tank(s) 11 on the upper chassis. As in the embodiment of FIGS. 5 to 8, the low pressure portion 21 of the supply line 18 and the connecting circuit 35 which connects the fuel cell 10 to the energy distribution device 14 pass via the rotating joint 25.

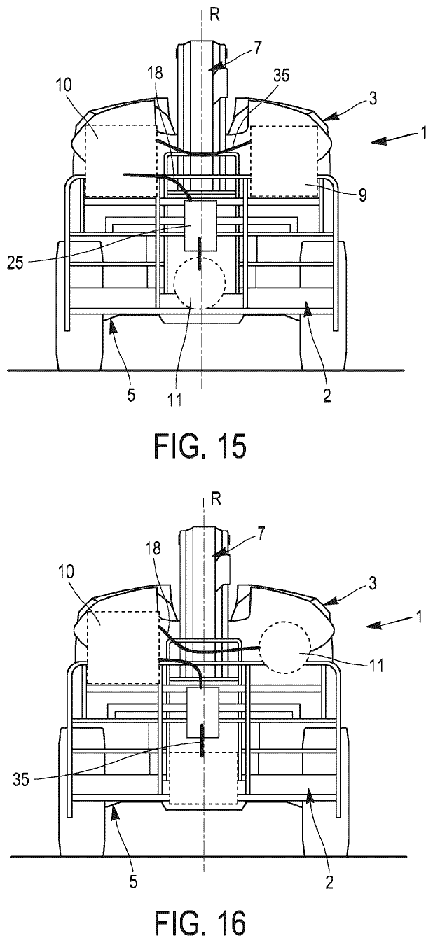

In the embodiment of FIG. 15, the device for storing electrical energy 9 and the fuel cell 10 are fixed to the upper structure 3 and respectively housed in a first and a second box formed on either side of the lifting arm 7, while the tank(s) 11 is/are mounted inside the lower structure 2. The pressure controller 19 is mounted with the tank(s) 11 on the lower structure 2. Moreover, as in the embodiment of FIGS. 1 to 4, the low pressure portion 21 of the supply line 18 passes via the rotating joint 25.

In the embodiment of FIG. 16, the fuel cell 10 and the tank(s) 11 are fixed to the upper structure 3, while the device for storing electrical energy 9 is fixed to the lower structure 2. The pressure controller 19 is also mounted with the tank(s) 11 on the upper chassis. As in the embodiment of FIGS. 9 to 12, the connecting circuit 35 which connects the fuel cell 10 to the energy distribution device 14 thus passes via the rotating joint 25 and no hydrogen can pass via said rotating joint 25.

While the invention has been described in connection with several specific embodiments, it is quite obvious that it is not limited in any way thereto and that it contains all of the technical equivalents of the means described, in addition to the combinations thereof if they fall within the scope of the invention.

The use of the verb “comprise”, “contain” or “include” and its conjugated forms does not exclude the presence of further elements or further steps than those cited in a claim.

In the claims, any reference sign between parenthesis should not be interpreted as a limitation of the claim.

1. Handling machine (1) comprising:
a chassis comprising a lower structure (2) and an upper structure (3) rotatably mounted on the lower structure (2) about a vertical axis;
a lifting arm (7) which is movably mounted on the upper structure (3);
a first assembly comprising a device for storing electrical energy (9),
a second assembly comprising a fuel cell (10) which is configured to generate electrical energy designed to be stored in the device for storing electrical energy (9), said fuel cell (10) being electrically connected to the device for storing electrical energy (9) via a connecting circuit (35); and
a third assembly comprising at least one tank (11) designed to contain hydrogen and connected to the fuel cell (10) via a supply line (18) in order to supply it with hydrogen;
said supply line (18) comprising a pressure controller (19), an upstream portion (20) connecting the tank (11) and the pressure controller (19) and a downstream portion (21) connecting the pressure controller (19) and the fuel cell (10),
wherein one of the first, the second and the third assemblies is fixed to one of the lower and upper structures (2, 3) and the two others of the first, second and third assemblies are fixed to the other of the lower and upper structures (2, 3);
wherein the pressure controller (19) and the upstream portion (20) of the supply line (18) are fixed to that of the lower (2) and upper structures (3) to which the third assembly is fixed; and wherein the handling machine (1) comprises a rotating joint (25) connecting the lower structure (2) and the upper structure (3), the downstream portion (21) of the supply line (18) passing through said rotating joint (25) when the second assembly and the third assembly are respectively fixed to one another of the lower and upper structures (2, 3) and/or the connecting circuit (35) passing through said rotating joint (25) when the second assembly and the first assembly are respectively fixed to one and the other of the lower and upper structures (2, 3).

2. The handling machine (1) as claimed in claim 1, wherein one of the first, the second and the third assemblies is fixed to the upper structure (3) and the two others of the first, second and third assemblies are fixed to the lower structure (2) and housed in a first box and a second box of said lower structure (2).

3. The handling machine (1) as claimed in claim 2, wherein the first box and the second box are formed in the lower structure (2) on either side of a longitudinal median plane of the handling machine (1).

4. The handling machine (1) as claimed in claim 2 or 3, comprising a driver's cab (6) mounted on the upper structure (3) and wherein that of the first, second and third assemblies which is fixed to the upper structure (3) and said driver's cab (6) are positioned on either side of the lifting arm (7).

5. The handling machine (1) as claimed in any one of claims 2 to 4, wherein the first assembly, the second assembly and the connecting circuit (35) are fixed to the lower structure (2), the third assembly, the pressure controller (19) and the upstream portion (20) of the supply line (18) being fixed to the upper structure (3) and the downstream portion (21) of the supply line (18) passing via the rotating joint (25).

6. The handling machine (1) as claimed in any one of claims 2 to 4, wherein the first assembly, the third assembly, the pressure controller (19) and the upstream portion (20) of the supply line (18) are fixed to the lower structure (2), the second assembly being fixed to the upper structure (3) and wherein the downstream portion (21) of the supply line (18) and the connecting circuit (35) pass via the rotating joint (25).

7. The handling machine (1) as claimed in any one of claims 2 to 4, wherein the second assembly, the third assembly and the supply line (18) are fixed to the lower structure (2), the first assembly being fixed to the upper structure (3) and the connecting circuit (35) passing via the rotating joint (25).

8. The handling machine (1) as claimed in claim 1, wherein one of the first, the second and the third assemblies is fixed to the lower structure (2) and the two others of the first, second and third assemblies are fixed to the upper structure (3) and housed in a first box and a second box of said upper structure (3).

9. The handling machine (1) as claimed in claim 8, wherein the first box and the second box are formed in the upper structure (2) on either side of the lifting arm (7).

10. The handling machine (1) as claimed in claim 8 or 9, wherein the first assembly, the third assembly, the pressure controller (19) and the upstream portion (20) of the supply line (18) are fixed to the upper structure (3), the second assembly being fixed to the lower structure (2) and wherein the downstream portion (21) of the supply line (18) and the connecting circuit (35) pass via the rotating joint (25).

11. The handling machine (1) as claimed in claim 8 or 9, wherein the first assembly, the second assembly and the connecting circuit (35) are fixed to the upper structure (3), wherein the third assembly, the pressure controller (19) and the upstream portion (20) of the supply line (18) are fixed to the lower structure (2), the downstream portion (21) of the supply line (18) passing via the rotating joint (25).

12. The handling machine (1) as claimed in claim 8 or 9, wherein the second assembly, the third assembly, the pressure controller (19) and the supply line (18) are fixed to the upper structure (3), the first assembly being fixed to the lower structure (2) and wherein the connecting circuit (35) passes via the rotating joint (25).
